(19) United States
(12) Patent Application Publication
(10) Pub. No.: US 2008/0191515 A1
(43) Pub. Date: Aug. 14, 2008

(54) Truck with Cab Having Longitudinally Oriented Bunk

(75) Inventor: Bruce P. Hollenbeck, Orefield, PA (US)

Correspondence Address: WRB-IP LLP, 1217 KING STREET, ALEXANDRIA, VA, 22314, US

(73) Assignee: MACK TRUCKS, INC., Allentown, PA (US)

(21) Appl. No.: 11/917,220

(22) PCT Filed: Jun. 22, 2005
(86) PCT No.: PCT/US05/22047

§ 371 Date: Dec. 12, 2007

(51) Int. Cl. B60N 3/00; B60P 3/32

(52) U.S. Cl. 296/190.02

(57) ABSTRACT

A truck includes a cab and a bunk disposed in the cab. The bunk has a head and a foot at opposite ends of the bunk and a longitudinal axis between the head and the foot, the longitudinal axis extending parallel to a longitudinal axis of the truck.

### BACKGROUND AND SUMMARY

The present invention relates generally to trucks and, more specifically, to trucks including bunks.

In existing trucks having sleeper cabs, the bunk extends laterally in the sleeper cab and is disposed along the rear wall of the sleeper cab. By orienting the bunk laterally, side-to-side motion of the truck is less likely to disturb a person on the bunk.

Because swaying motions in truck sleeper cabs become more pronounced at greater heights, bunks are positioned relatively close to the floor. Occasionally, cabinets or other structures are disposed beneath the bunks.

The inventor has recognized that the lateral orientation and low position of bunks in conventional sleeper cabs wastes space and substantially limits the amount of furnishings that can be provided in the sleeper cab. Recent, as well as expected, U.S. regulations for truck drivers require drivers to have a certain amount of sleeping time and off-duty time in addition to their driving time. The inventor expects that, in trucks in the future, the availability of space available sleeper cab will be of a much greater importance than in the past. The inventor expects that it will, for example, be desirable to provide a greater amount and a wider variety of types of furnishings and other items in trucks in the future. In addition, because drivers are now required to keep substantially more detailed log books and records, the inventor has recognized that a more substantial workspace than, for example, the driver's lap is now highly desirable.

In accordance with an aspect of the present invention, a truck comprises a sleeper cab and a bunk disposed in the sleeper cab. The bunk has a head and a foot at opposite ends of the bunk and a longitudinal axis between the head and the foot, the longitudinal axis extending parallel to a longitudinal axis of the truck.

In accordance with another aspect of the present invention, a truck comprises a cab and a bunk disposed in the cab. The bunk has a head and a foot at opposite ends of the bunk and a longitudinal axis between the head and the foot, the longitudinal axis extending parallel to a longitudinal axis of the truck.

### BRIEF DESCRIPTION OF THE DRAWINGS

The features and advantages of the present invention are well understood by reading the following detailed description in conjunction with the drawings in which like numerals indicate similar elements and in which:

FIG. 1 is a side, partially broken view of a truck according to an embodiment of the present invention;

FIG. 2 is a side view of an interior arrangement of a truck according to an embodiment of the present invention;

FIG. 3 is a side view of an interior arrangement of a truck according to another embodiment of the present invention; and

FIG. 4 is a perspective view of an interior arrangement of a truck according to an embodiment of the present invention.

### DETAILED DESCRIPTION

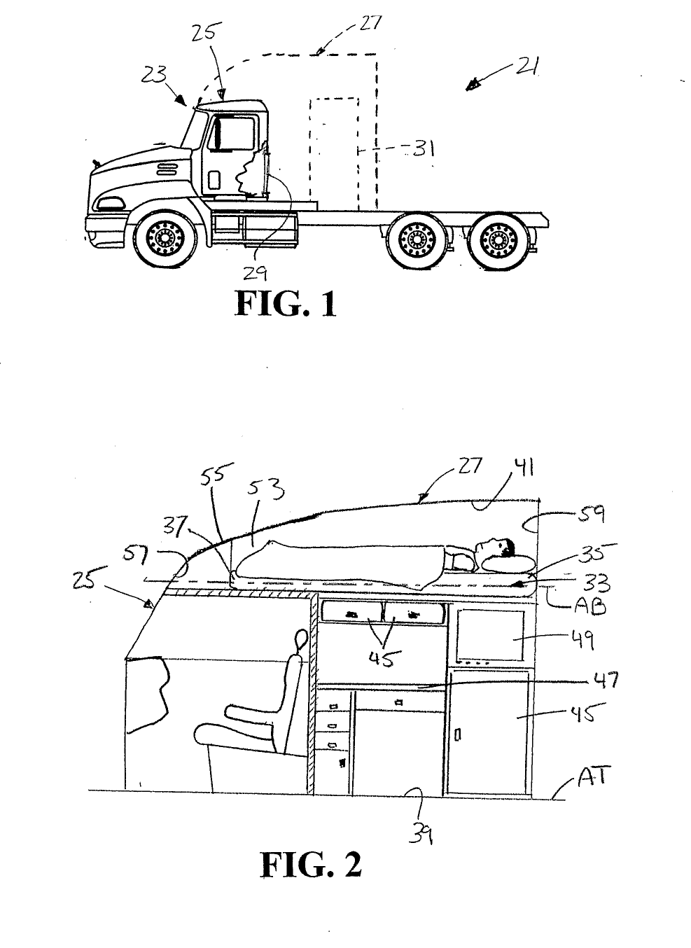

A truck 21 according to an embodiment of the present invention is shown in FIG. 1. The truck 21 comprises a cab 23. The cab 23 comprises a driver's portion 25. The truck 21 further comprises a sleeper cab 27 (shown in phantom). The sleeper cab 27 may an integral part of the cab 23, such as by being secured directly to the driver's portion 25, or the sleeper cab may be mounted on the frame of the truck separately from the driver's portion (not shown). A passage 29 may be provided between the driver's portion 25 and the sleeper cab 27. A door 31 provided in a longitudinal wall of the sleeper cab 27 may be provided instead of or in addition to the passage 29 between the driver's portion 25 and the sleeper cab. The driver's portion 25 of the cab 23 may also be completely or substantially sealed from the sleeper cab 27.

As seen in FIG. 2, a bunk 33 is disposed in the sleeper cab 27. The bunk 33 has a head 35 and a foot 37 at opposite ends of the bunk and a longitudinal axis AB between the head and the foot. The longitudinal axis AB extends along a longitudinal axis AT of the truck 21.

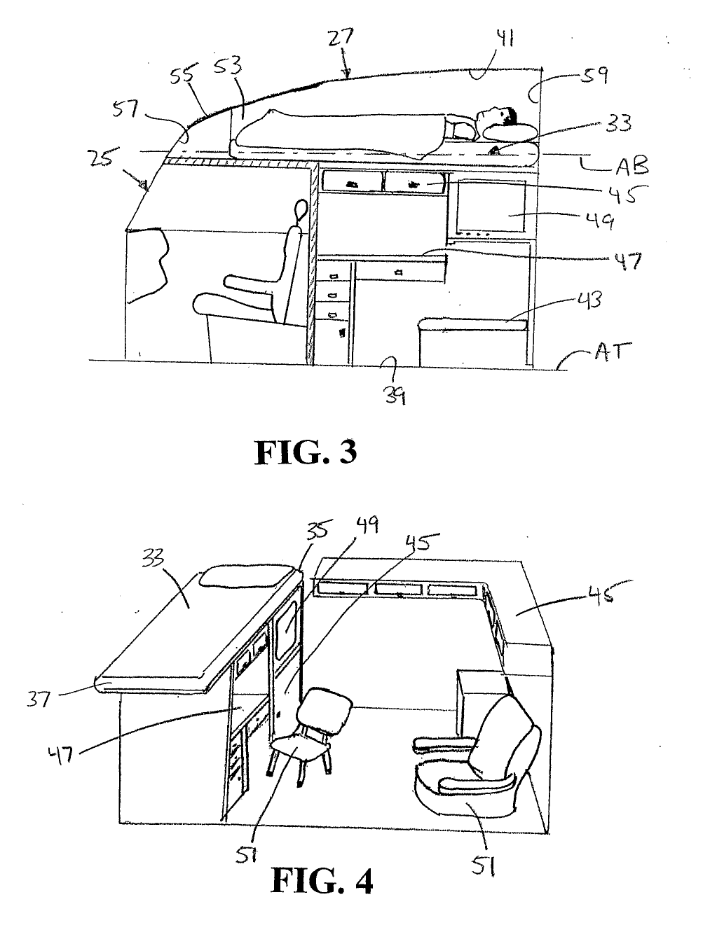

In the truck 21 shown in FIG. 2, the sleeper cab 27 has a floor 39 and a ceiling 41 and the bunk 33 is disposed closer to the ceiling than to the floor, although, in other embodiments, the bunk may be disposed closer to the floor than to the ceiling, or exactly in between the floor and the ceiling. As seen in FIG. 3, a second bunk 43 may be disposed vertically beneath the first bunk 33, either directly beneath the first bunk or offset from the first bunk. The longitudinal axis of at least one of the first bunk 33 and the second bunk 43 extends parallel to the longitudinal axis AT of the truck.

Positioning a bunk 33 closer to the ceiling 39 than to the floor 41 facilitates positioning of other components beneath the bunk. For example, as seen in FIGS. 2, 3, and 4, at least one cabinet 45 can be disposed beneath the bunk 33. Cabinets 45 can also be disposed vertically above the bunk 33 and may be mounted along one or more of the walls, the ceiling, and the floor.

As also seen in FIG. 3, at least one desk 47 can be disposed beneath the bunk 33. Other items such as appliances 49 such as a television, a microwave oven, and the like, and furnishings 51 (FIG. 4) such as chairs, tables, and the like can also be disposed beneath the bunk 33. While articles such as the cabinet 45, the desk 47, the appliances 49, and furnishings such as a seat 51 can be disposed directly beneath the bunk 33, i.e., inside the footprint of the bunk, they may also be disposed partially or entirely outside of the footprint of the bunk as seen in FIG. 4.

In the embodiments in FIGS. 2 and 3, the sleeper cab 27 includes a roof fairing space 53 beneath the roof fairing 55. At least part of the bunk 33 may be disposed in the roof fairing space 53. The sleeper cab 27 includes a front end 57 and a rear end 59 and, in the embodiments of FIGS. 2 and 3, the head 35 of the bunk 33 is disposed closer to the rear end than the foot 37 of the bunk. Of course, in other embodiments (not shown), the foot of the bunk may be disposed closer to the rear end of the sleeper cab than the head of the bunk.

In the embodiments of FIGS. 2 and 3, the cab 23 includes the driver's portion 25, and at least part of the bunk 33 is disposed vertically over the driver's portion. As seen in FIG. 4, the bunk 33 can be disposed on the right hand side of the truck 21 such that it will extend above the passenger's side seat in the driver's portion. If desired, the bunk can be disposed on the left hand side of the truck, or between the left and the right hand sides of the truck.

In the embodiments of FIGS. 2 and 3, the roof fairing space 53 extends over the driver's portion 25 and the foot 37 of the bunk 33 is disposed vertically above the driver's portion. In other embodiments (not shown), the fairing begins behind the driver's portion. The bunk may, nonetheless, extend above the driver's portion, such as by extending through a passage between the driver's portion and the sleeper cab.

In the present application, the use of terms such as “including” is open-ended and is intended to have the same meaning as terms such as “comprising” and not preclude the presence of other structure, material, or acts. Similarly, though the use of terms such as “can” or “may” is intended to be open-ended and to reflect that structure, material, or acts are not necessary, the failure to use such terms is not intended to reflect that structure, material, or acts are essential. To the extent that structure, material, or acts are presently considered to be essential, they are identified as such.

While this invention has been illustrated and described in accordance with a preferred embodiment, it is recognized that variations and changes may be made therein without departing from the invention as set forth in the claims.

What is claimed is:

1. A truck, comprising:
a sleeper cab; and
a bunk disposed in the sleeper cab, the bunk having a head and a foot at opposite ends of the bunk and a longitudinal axis between the head and the foot, the longitudinal axis extending parallel to a longitudinal axis of the truck.

2. The truck as set forth in claim 1, wherein the sleeper cab has a floor and a ceiling, the bunk being disposed closer to the ceiling than to the floor.

3. The truck as set forth in claim 2, comprising at least one cabinet disposed beneath the bunk.

4. The truck as set forth in claim 3, comprising at least one desk disposed beneath the bunk.

5. The truck as set forth in claim 2, comprising at least one desk disposed beneath the bunk.

6. The truck as set forth in claim 2, wherein the sleeper cab includes a roof fairing space and at least part of the bunk is disposed in the roof fairing space.

7. The truck as set forth in claim 6, wherein the sleeper cab includes a front and a rear end, the head being disposed closer to the rear end than the foot.

8. The truck as set forth in claim 2, wherein the truck includes a cab having a driver's portion, and at least part of the bunk is disposed vertically over the driver's portion.

9. The truck as set forth in claim 1, comprising at least one cabinet disposed beneath the bunk.

10. The truck as set forth in claim 9, comprising at least one desk disposed beneath the bunk.

11. The truck as set forth in claim 9, comprising at least one cabinet disposed outside of a footprint of the bunk.

12. The truck as set forth in claim 1, comprising at least one desk disposed beneath the bunk.

13. The truck as set forth in claim 1, wherein the sleeper cab includes a front and a rear end, the head being disposed closer to the rear end than the foot.

14. The truck as set forth in claim 1, wherein the truck includes a cab having a driver's portion, and at least part of the bunk is disposed vertically over the driver's portion.

15. The truck as set forth in claim 14, comprising a passage between the driver's portion of the cab and the sleeper cab.

16. The truck as set forth in claim 1, comprising at least one seat disposed in the sleeper cab.

17. The truck as set forth in claim 1, comprising a second bunk disposed vertically beneath the first bunk.

18. The truck as set forth in claim 1, comprising a door in the sleeper cab for permitting entry into and exit from the cab.

19. A truck, comprising:
a cab; and
a bunk disposed in the cab, the bunk having a head and a foot at opposite ends of the bunk and a longitudinal axis between the head and the foot, the longitudinal axis extending parallel to a longitudinal axis of the truck.

20. The truck as set forth in claim 19, wherein the cab includes a driver's portion and a sleeper portion.
